(19) United States
(12) Patent Application Publication
(10) Pub. No.: US 2006/0236255 A1
(43) Pub. Date: Oct. 19, 2006

(54) Method and apparatus for providing audio output based on application window position

(75) Inventors: Donald J. Lindsay, Mountain View, CA (US); Martin Van Tilburg, Seattle, WA (US); Pieter Diepenmaat, Delft (NL)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/107,840

(22) Filed: Apr. 18, 2005

(51) Int. Cl. G06F 9/00

(52) U.S. Cl. 715/766

(57) ABSTRACT

In a computer system, a technique is provided by which audio output (e.g., a notification) from an application associated with an application window is modified in a manner that provides a user with an indication as to the location of the application window. The application window may be partially or wholly obscured by another application window, minimized or otherwise part of a crowded desktop space. In modifying the audio output by affecting the volume, pitch or otherwise manipulating the sound can provide the user with an intuitive sense as to the location of the application window originating the audio output.

### FIELD OF THE INVENTION

Aspects of the present invention are directed generally to window arrangements in an operating system. More particularly, aspects of the present invention are directed to a method and system for modifying audio output generated by an application based on the application window position.

### BACKGROUND OF THE INVENTION

As the use of computers in both the workforce and personal life has increased, so has the desire to allow for easier use of them. Many operating systems today utilize a windows based configuration of application programs. Information is displayed on a display screen in what appears to be several sheets of paper.

In existing environments application windows are a core user interface facility for the graphical user interface (GUI) of computer systems. While application windows can vary in appearance across systems, they have multiple attributes in common. For example, application windows typically have a title bar including window management controls such as a “close” button to dismiss the window, the ability to resize or reposition the window, and the ability to coexist with other windows from the same application or different applications. Multiple application windows can be presented on screen in a layered manner called a “Z-order” based on a set of common rules. For example, the application windows can change their position in a visual stack based on which application window is active and in focus. Thus, when multiple application windows are presented on a GUI, the active window is at the top of the Z-order while the remaining windows are inactive and located below the active window in the Z-order typically in the order each window was last accessed from most recently accessed down to least recently accessed.

In GUIs today, system and application visual or audio notifications are provided by the GUI to application developers to notify a user of an event or action that requires a user's attention (e.g., a calendar event) or an action that has been requested by a user that is not currently available or allowed. For example, when an application associated with a window not at the top of the visual stack needs to notify a user of the occurrence of an event, the application may generate an audio cue such as a “sysbeep” and/or may cause a visual cue such as a flash to occur within the window. Irrespective of the position of the window on the screen or within the visual stack, the same audio and/or visual cue is presented.

When multiple windows are presented on the GUI at the same time, switching quickly to the window running the application that generated the notification can be difficult. For example, the desired window may be partially or fully occluded by other application windows. Also, the desired window may be minimized or hidden. Accordingly, it would be helpful to provide a further indication as to the location of the application window which generated the notification.

### SUMMARY OF THE INVENTION

There is therefore a need to provide a further indication as to the position of an application window associated with an application generating a notification to allow users to quickly and easily locate the window.

According to aspects of the present invention, a technique is provided by which audio output (e.g., notification) from an application associated with an application window is modified in a manner that provides a user with an indication as to the location of the application window. Often the application window may be wholly or partially obscured by one or more application windows, minimized or otherwise part of a crowded desktop space. In modifying the audio output by affecting the volume, pitch or otherwise manipulating the sound, the user can be provided with an intuitive sense as to the location of the application window originating the audio output.

According to one aspect of the invention, the audio output generated by an application associated with an application window is modified based on the degree to which the application window is obscured or partially off screen. For example, the audio output may be muffled as a function of the degree to which the application window is obscured. In another aspect, the audio output may be modified based on the position in the Z-order of the application window originating the audio output. In other aspects, the horizontal and vertical positions of the application window can affect how the audio output is modified. For example, to indicate horizontal position, an application window on the left side of the display screen can result in the audio output being stereophonically reproduced primarily or exclusively through the left speaker. To indicate vertical position, the pitch of the audio output may be increased the higher up the display screen the application window is located. In still another aspect, whether the application window is minimized can influence how the audio output is modified.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1A illustrates a schematic diagram of a general-purpose digital computing environment in which certain aspects of the present invention may be implemented.

FIGS. 1B through 1M show a general-purpose computer environment supporting one or more aspects of the present invention.

FIG. 2 illustrate a display screen including application windows that is used to assist in describing aspects of the present invention.

FIG. 3 illustrate a display screen including application windows that is used to assist in describing aspects of the present invention.

FIG. 4 provides a flowchart of an illustrative example of a method for generating audio output according to aspects of the present invention.

### DETAILED DESCRIPTION OF ILLUSTRATIVE EMBODIMENTS

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

Illustrative Operating Environment

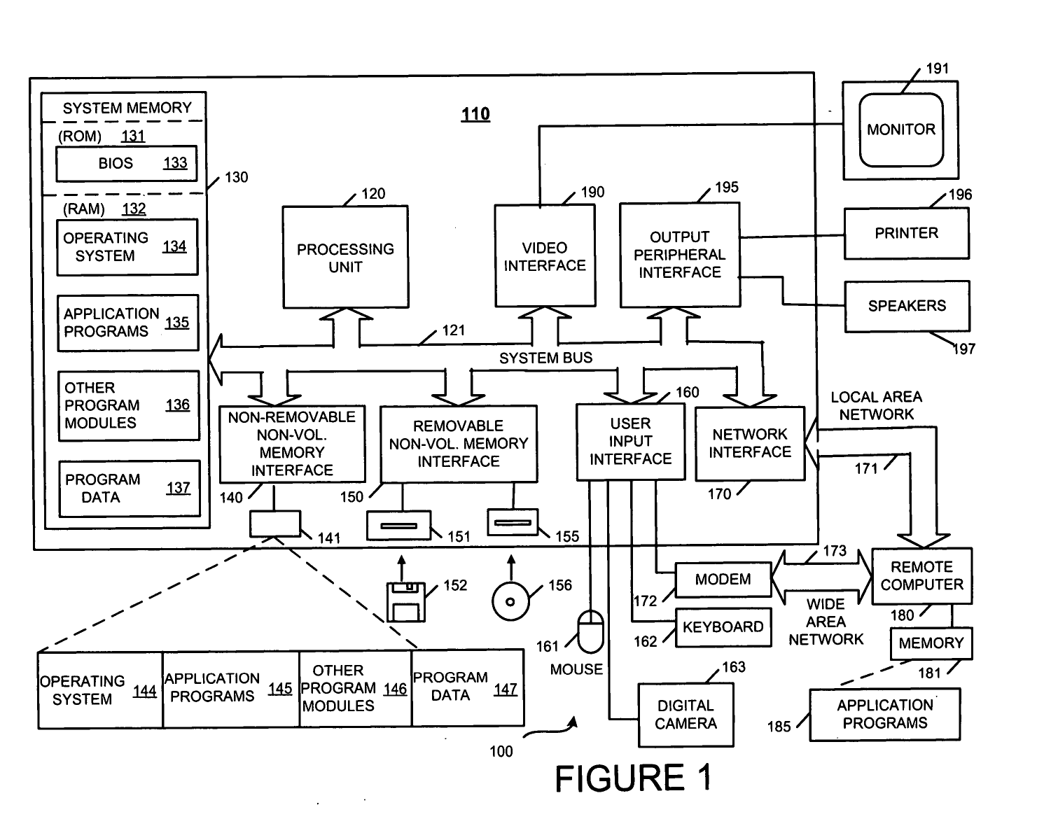

FIG. 1A illustrates an example of a suitable computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1A illustrates operating system 134, application programs 135, other program modules 136, and program data 137.

The computer 110 may also include other removable/non-removable, volatile/nonvolatile computer storage media. By way of example only, FIG. 1A illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a digital camera 163, a keyboard 162, and pointing device 161, commonly referred to as a mouse, trackball or touch pad. Other input devices (not shown) may include a pen, stylus and tablet, microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1A include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1A illustrates remote application programs 185 as residing on memory device 181. It will be appreciated that the network connections shown are exemplary and other means of establishing a communications link between the computers may be used.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 1B and 1C, but they nonetheless perform a similar function to accomplish the same overall result. We will now briefly describe some illustrative alternative implementations of a programming interface.

### A. Factoring

A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square (input, precision, output), a call that includes three parameters, input, precision and output, and which is issued from the 1st Code Segment to the 2nd Code Segment. If the middle parameter precision is of no concern in a given scenario, as shown in FIG. 1F, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

### C. Inline Coding

It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 1C performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

### D. Divorce

A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 1C to a new operating system, while providing the same or similar functional result.

### E. Rewriting

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

### ILLUSTRATIVE EMBODIMENTS

In the real world, when one object obscures another object that produces a sound, the sound becomes distorted. Namely, the sound is modified based on the characteristics of the obscuring object. For example, when a person speaks, if they place their hand in front of their mouth, their speech is effectively “muffled” or distorted. In this example, the volume of the sound may be lowered and/or the range of frequencies narrowed such that the fidelity of the sound is affected or distorted. Characteristics such as size of the object in front of the sound source and the material composition (e.g., wood, metal, glass, etc.) of the object can cause the sound to be modified in varying ways according to those attributes of the object.

Aspects of the invention provide audio output in response to the occurrence of an event. In addition to serving as a notification however, the audio output also serves as an indicator as to the application window which originated the notification. For example, in some aspects, a real world metaphor for modifying the audio output associated with an application window provides audio output that indicates the position or placement on the display screen of the application window which originated the notification. Illustrative events that can cause a notification to be generated include, but are not limited to, calendar events (notification of an appointment), user defined events, system events (e.g., error condition) and any other types of activities that cause an application to generate an audio notification.

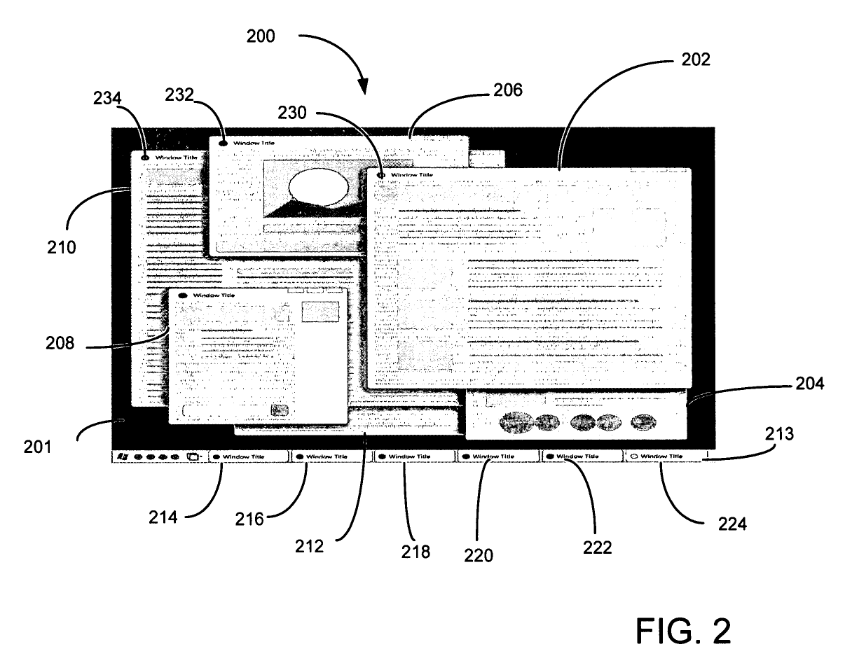

FIG. 2 illustrates a display screen 200 with multiple application windows overlapping each other. Various application windows 202, 204, 206, 208, 210 and 212 are shown in a Z-order orientation. It should be understood by those skilled in the art that the Z-order of an orientation of application windows is very well known in the art. In FIG. 2, window 202 is higher in the Z-order than windows 204, 206, 208, 210 and 212. Window 204 is higher in the Z-order than windows 206, 208, 210 and 212. Window 206 is higher in the Z-order than windows 208, 210 and 212. Window 208 is higher in the Z-order than windows 210 and 212, and window 210 is higher in the Z-order than window 212. Window 212 is at the bottom of the Z-order in this example. As used herein, the term “orientation” is defined to include adjustments to the visual appearance of a window or group of windows, such as the size or shape of the window and a shared common border between or around at least two windows.

Desktop space 201 is an area or region of a display that allows for the display of application windows corresponding to application programs. A taskbar 213 at the bottom of the display serves as a control region that indicates the application windows that are currently in use including application windows that are displayed in the desktop space 201 as well as any minimized application windows. The taskbar 213 is a specific implementation of an on-screen window remote control used to list and enable manipulation of application windows, such as activating, moving, hiding, and minimizing. Window 202 may be represented by application tile 214. Window 204 may be represented by application tile 216. Window 206 may be represented by application tile 218. Window 208 may be represented by application tile 220. Window 210 may be represented by application tile 222. Window 212 may be represented by application tile 224. As shown in this example, all six of the application windows represented on the taskbar 213 are shown in the desktop space 201. Although only six application windows are shown, it should be understood that more or fewer application windows may be open. The application tile order may indicate the order in which the corresponding application windows were first opened. For example, window 206 is the third window from the top of the Z-order as shown by its corresponding application tile 218, while window 212 was the least recent window opened in comparison to the other five windows.

Each of windows 202, 204, 206, 208, 210 and 212 includes an indicium, respectively, corresponding to the application program using the window. For example, windows 202, 206 and 210 respectively include indicium 230, 232, 234. It should be understood by those skilled in the art that any particular window may or may not include a corresponding indicium.

In today operating systems, applications utilize the graphical user interface (GUI) to provide visual or audio output in the form of notifications to notify users of: 1) an event or action that requires the user's attention; or 2) that an action requested is not currently available or allowed. For example, an application window, whether or not in focus (e.g., at the top of the Z-order), that needs to provide a notification to the user may provide a visual and/or audio cue such as a visual flash and/or a complementary audio beep (e.g., sysbeep). Regardless of the application window position on the display screen or position in the Z-order, the same visual and/or audio output is presented.

In some orientations, one or more windows may completely obscure an underlying window in the Z-order. In such a case, a user will not be able to see the underlying window. The contents of other windows may be partially obscured by other windows higher in the Z-order. Referring to FIG. 2, when a notification originates from an application associated with an application window not at the top of the Z-order or in focus and partially obscured such as windows 204, 210 and 212 shown in FIG. 2, it can become increasingly difficult for the user to determine which application window originated the notification irrespective of whether the notification is visual and/or audio.

Aspects of the invention provide audio output in response to an application notification. The audio output serves both as a notification of an event and as an indicator of the position of the application window which originated the notification. In some aspects, a real world metaphor for modifying the audio output associated with an application window provides audio output that indicates the position or placement on the display screen of the application window which originated the notification. For example, the invention can determine the location of the application window that originated the notification and modify the audio output to provide the user with a cue or indication as to the location of the application window. As a result, the application window can be more easily and quickly identified and the notification can be resolved more quickly.

To provide an indication as to the position of an application window generating a notification, the audio output can be distorted (e.g., muffled) when the originating application window is obscured by one or more other application windows on the display screen or when the originating application window is moved partially off the desktop space of the display screen. For example, the audio output can be distorted based on the degree (e.g., percentage) to which the application window is obscured or off screen; the more obscured or off screen the application window, the more the audio output is distorted or muffled. For example, if an application window originating the audio output is only slightly obscured, then the audio output may be modified to a small degree, whereas if the application window is substantially obscured, the modification of the audio output may be substantially exaggerated.

Some variables that can affect how the sound is modified relate to the characteristics of the application windows obscuring the application window originating the audio output. For example, the size of the obscuring window can increase the modification applied. In one aspect, the material that the window border is drawn to visually represent can affect the sound modification. For example, some operating systems include themes where windows can be drawn to have a glass, wood or metal borders. The audio output for an application window obscured by a window drawn to have a metal border can be generated with a higher resonance than an application window obscured by a window drawn to have a wood border.

It will be appreciated that throughout the description, the concept of the application associated with an application window generating or originating the audio output is also referred to as the application window generating or originating the audio output.

Turning to FIG. 2, audio output originating from application window 206 would be distorted to a much lesser degree than audio output from application window 212. By applying the real world metaphor of muffling, when an application window at least partially obscured by other windows generates an audio output, the output can be modified to incorporate a muffling effect such that the amount of muffling will allow the user to look at the display screen and intuitively determine which application window generated the audio output based on the degree to which the window is obscured.

In a related aspect, the audio output can be muffled based on its location in the Z-order. Turning to FIG. 2 again, the amount of distortion in the audio output increases the farther down in the Z-order the application window is positioned. Thus, an audio notification output by application window 212 would be more distorted than an audio output from application window 210, which would be more distorted than an output by application window 208 and so on. The amount of distortion applied to the audio output could be a function of how many open windows exist. While the range of distortion used to identifying the location of a window in the Z-order may be fixed, the difference between the amounts of distortion from window to window in the Z-order may be a function of how many windows are in the Z-order. For example, in a Z-order of five windows, the bottom and middle windows might have the same amount of distortion as the bottom and middle windows in a Z-order of nine windows, but the window second from the bottom in each Z-order would have a different amount of distortion.

It will be appreciated by one skilled in the art that sound can be modified and sound effects can be generated in numerous different ways in applying the principles of the present invention. Modifying the audio output could involve altering the volume, narrowing the range of frequencies or otherwise affecting the pitch, changing the timbre, mixing in white noise, or other known methods of modifying sound.

In other aspects of the invention, the audio output generated by an application window can be modified to reflect the horizontal position of the application window on the display screen. For example, the audio output can be stereophonically reproduced to provide an indication as to whether the application window is located on the left side of the display screen or the right side of the display screen. Also, the degree of stereophonic reproduction can indicate how close to the left or right edge of the display screen the application window is located. In this aspect, the real word metaphor of right and left side sound is employed to provide a user with an indication as to the location of the application window originating the sound.

Referring to FIG. 2, if application window 208 generates the audio output then the audio would be output more pronounced in the left speaker, whereas if the application window 204 generates the audio output then the audio would be output more pronounced in the right speaker. Since windows are of different sizes, generally the center position of the window would be used to determine the horizontal position.

In another aspect of the invention, the audio output generated by an application window can be modified to reflect the vertical position of the application window on the display screen. For example, the pitch of the audio output can be increased to represent a window located at the top of the display screen or decreased to represent a window located at the bottom of the screen.

Referring to FIG. 2, if application window 206 generates the audio output then the pitch of the audio output would be greater than the normal pitch of the audio notification, whereas if the application window 208 generates the audio output then the audio output would be less than the normal pitch of the audio notification. Since windows are of different sizes, generally the center position of the window would be used to determine the vertical position.

It will be appreciated that the audio output can be modified to represent both the horizontal and vertical position of the originating application window. For example, a high pitched audio output from the left speaker can be generated when application window 206 generates an audio output. Furthermore, the audio output could be partially muffled as well to represent the position of the application window in the Z-order or the degree to which the application window is obscured by application window 202.

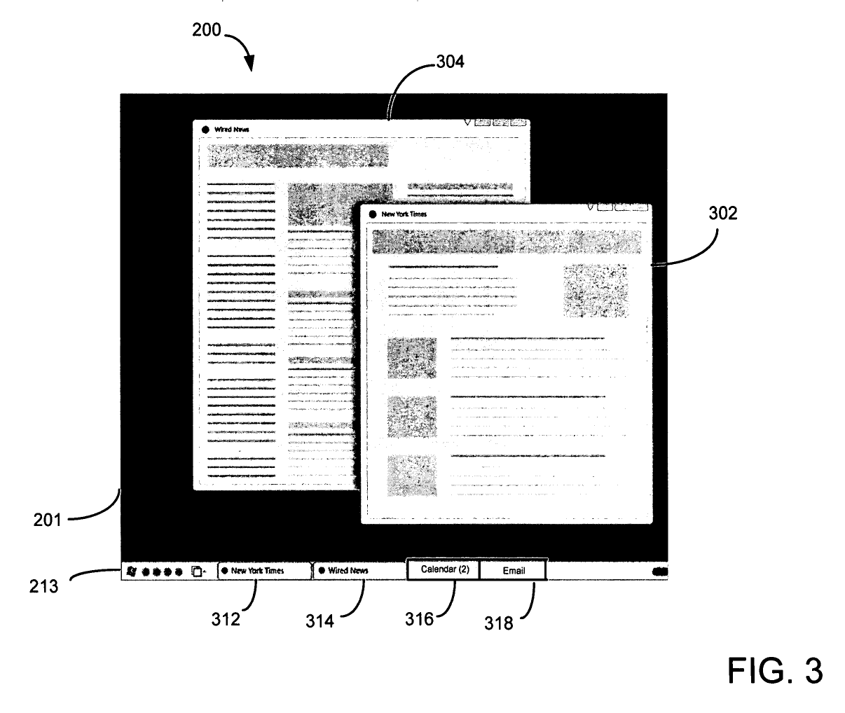

FIG. 3 illustrates a display screen 200 including desktop space 201 and taskbar 213. The desktop space 201 includes application windows 302 and 304. The taskbar 213 includes application tiles 312, 314, 316 and 318. Application tiles 312 and 314 correspond to application windows 302 and 304, respectively. Application tiles 316 and 318 correspond to minimized application windows. Application tile 316 actually corresponds to a glom with two application windows.

Aspects of the present invention can be applied to minimized application windows as well as windows presented in the desktop space 201. Referring to FIG. 3, an application associated with an application window represented by either application tile 316 or application tile 318 on the taskbar 213 can generate a notification. The audio output from an application generated by a minimized application window could be the most muffled (as it is fully obscured), have the lowest pitch (if the taskbar is at the bottom of the screen) or could be modified with a unique effect to indicate that it is minimized and accessible via the taskbar. A glommed application could include a visual notification such that when a user opens the glom application tile 316, the glommed application which generated the audio output would be highlighted. Also, the audio output could be modified to represent the horizontal position of the application tile associated with the minimized application on the taskbar 213. It should be understood that any combination of effects can be used as appropriate to provide the user with an indication as to the position of the application window originating the audio output.

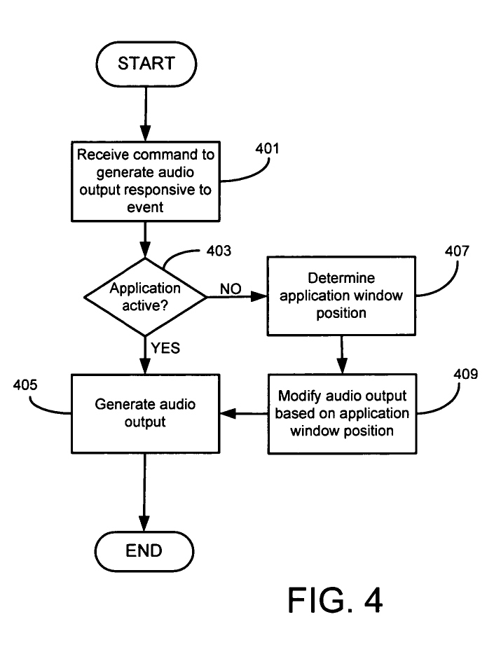

FIG. 4 provides a flow chart showing the steps to generate an audio output in response to an illustrative implementation of the present invention. Initially, the system receives a command from an application to generate an audio output in response to an event occurring in step 401. As discussed, events may be system (e.g., error condition) or user-defined events (e.g., notification regarding appointment or receipt of email) that trigger the process to generate an audio output. Next, the system determines whether the application is active at step 403. For example, the system can determine whether the application is at the top of the Z-order and in focus. If the application is active then the audio output requested is generated in step 405 and then the process ends.

However, if the application is inactive, such as minimized or below the top of the Z-order, in step 407, the system determines the location of the application window associated with the application that requested the audio output. According to aspects of the invention, the system may need to determine one or more of the following: 1) the horizontal position of the application window; 2) the vertical position of the application window; 3) the position of the application window in the Z-order; 4) whether the application window is minimized; 5) the degree to which the application window is obscured from view by, for example, other application windows; and 6) the characteristics (e.g., size, material that the window border is drawn to represent, etc.) of the application window(s) obscuring the subject window. Next, the audio output is modified based on the application window position in step 409. The process continues in step 405 where the modified audio output is generated. In this case the modified audio output reflects the location of the application window. Illustrative modifications to the audio output include changing the volume, changing pitch, applying stereophonic reproduction, adding distortion, adding sound effects and the like. After step 405, the process ends.

It will be readily understood that the invention could be applied to and is intended to encompass a multi-display environment. As such, the audio output generated by the originating application window could be modified in a multi-display environment as appropriate to represent the position of the application window.

In another implementation of the present invention, various aspects of the present invention may be performed by an application programming interface (API). For example, public APIs may interface with an operating system to allow an operating system to provide the various features of the present invention. In one embodiment, a software architecture stored on one or more computer readable media for processing audio output from an application associated with an application window and data representative of the location of the application window includes at least one component configured to modify the audio output to represent the location of the application window, and at least one application program interface to access the component. An API may receive a request to modify the audio output based on the location of the application window originating the request, access the necessary function(s) to perform the operation, and then send the results back to an operating system. The operating system may use the data provided from the API to perform the various features of the present invention.

In another implementation, a programming interface operable with an operating system, can perform the steps including intercepting an instruction to a destination module to generate an audio notification output from an application, intercepting data indicating the location of the application window associated with the application, and providing an instruction to the destination module to generate the audio output based on the location of the application window. The instruction can modify the audio output based on, for example, one or more of the horizontal position of the application window, the vertical position of the application window, the position of the application window in the Z-order, or the degree that the application window is obscured from view.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. In a computer system, a method comprising:
generating audio output from an application associated with an application window based on a location of the application window.

2. The method of claim 1, wherein the application window is one of a plurality of application windows presented in a Z-order on a display screen, the application window being below another one of the application windows in the Z-order.

3. The method of claim 2, wherein the audio output is based on a position of the application window in the Z-order.

4. The method of claim 2, wherein the step of generating includes modifying the audio output based on the degree to which the application window is obscured by one or more other application windows in the Z-order.

5. The method of claim 1, wherein the step of generating includes modifying the audio output to provide an indication as to the location of the application window.

6. The method of claim 5, wherein modifying includes muffling the audio output when the application window is obscured on a display screen.

7. The method of claim 5, wherein modifying includes stereophonically generating the audio output to represent the horizontal position of the application window on a display screen.

8. The method of claim 5, wherein modifying includes altering the pitch of the audio output to represent the vertical position of the application window on a display screen.

9. The method of claim 5, wherein modifying includes altering the audio output based on at least one characteristic of another application window in the Z-order which obscures the application window.

10. The method of claim 9, wherein the at least one characteristic includes window size.

11. The method of claim 9, wherein the at least one characteristic includes material that the window border is drawn to represent.

12. The method of claim 1, wherein the audio output is based on the vertical position of the application window.

13. The method of claim 1, wherein the application window is minimized and an application tile in a control region of a display screen represents the location of the application window.

14. The method of claim 1, wherein if the application window is minimized, the audio output generated differs from the audio output generated if the application window is visible.

15. The method of claim 1, wherein the audio output is based on the horizontal position of the application window.

16. One or more computer readable media having stored thereon computer-executable instructions for performing a method comprising:
generating audio output in response to occurrence of an event in an application associated with an application window including modifying the audio output based on a location of the application window on a display screen.

17. The computer readable media of claim 16 having stored thereon computer-executable instructions, further including modifying the audio output based on a position of the application window in a Z-order of a plurality of application windows.

18. The computer readable media of claim 17, wherein the step of generating includes distorting the audio output, the amount of distortion in the audio output increasing the farther down in the Z-order the application window is positioned.

19. The computer readable media of claim 16, wherein the step of generating includes modifying the audio output based on the degree to which the application window is obscured by other application windows.

20. A software architecture stored on one or more computer readable media for processing audio output from an application associated with an application window and data representative of the location of the application window, comprising:
at least one component configured to modify the audio output to represent the location of the application window; and
at least one application program interface to access the component.
